(19) United States
(12) Patent Application Publication
(10) Pub. No.: US 2018/0376031 A1
(43) Pub. Date: Dec. 27, 2018

(54) PROJECTION APPARATUS THAT IMPROVES DYNAMIC RANGE OF LUMINANCE OF PRINTED MATERIAL, CONTROL METHOD THEREFOR, AND STORAGE MEDIUM

(71) Applicant: CANON KABUSHIKI KAISHA, Tokyo (JP)

(72) Inventor: Nobuhiro Oka, Yokohama-shi (JP)

(21) Appl. No.: 16/008,551

(22) Filed: Jun. 14, 2018

(30) Foreign Application Priority Data
Jun. 22, 2017 (JP) 2017-122214

(51) Int. Cl. H04N 1/60; G06K 15/02; B41J 29/393

(52) U.S. Cl. CPC H04N 1/6033; B41J 29/393; G06K 15/027

(57) ABSTRACT

A projection apparatus which is capable of displaying an OSD from the projection apparatus in an easily viewable manner while maintaining an image quality improving effect. An image is projected on an observed object of a projection surface based on a projected image. A predetermined image is superimposed on the projected image. Pattern color correction is performed for at least an area of the projected image. In a case where an image based on the projected image superimposed with the predetermined image is projected, the pattern color correction is performed for an area of the projected image where the predetermined image is superimposed, whereas the pattern color correction is not performed for another area of the projected image.

### BACKGROUND OF THE INVENTION

### Field of the Invention

The present invention relates to a projection apparatus, a control method therefor, and a storage medium, and in particular to a projection apparatus and a control method therefor which improve a dynamic range of luminance of printed matter by superimposing a projected image onto the printed matter from the projection apparatus, as well as a storage medium.

### Description of the Related Art

Lately, there are increasing opportunities to handle an image of a subject shot by a digital camera or the like as a high dynamic range image having a high dynamic range (hereafter referred to as an “HDR image”).

It is expected that usage of HDR images will increase because expressive power for color, gradation, texture, and so forth can be increased by faithfully reproducing a contrast of a subject as actually seen by a person.

On the other hand, although direct-view-type devices such as liquid crystal displays and organic EL displays are enhancing display abilities, their reproduction range is generally about 1 to 1000 cd/m². Therefore, for example, when reproducing an HDR image with a brightness exceeding 1000 cd/m² by means of those direct-view-type devices, it is necessary to carry out a dynamic range compression process called tone mapping. This means that in this case, a dynamic range which an HDR image originally has is not expressed to a satisfactory degree.

Examples of techniques proposed to express a wide dynamic range include a technique that improves a dynamic range of luminance of printed matter, and by extension its image quality by superimposing a projected image on the printed matter from a projection apparatus (see, for example, Japanese Laid-Open Patent Publication (Kokai) No. 2008-83180).

It should be noted that in order to superimpose a projected image from the projection apparatus at a desired position on an observed object such as printed matter, a lens shift position adjustment function, a focus adjustment function, and a keystone correction function for the projected image, and so forth of the projection apparatus are generally used. A color and luminance of a projected image from the projection apparatus are also adjusted so that an observed object can look as desired.

In general, to control various such functions of the projection apparatus, a user of the projection apparatus projects OSDs (on-screen displays) such as a menu and a guidance from the projection apparatus and sees or operates the OSDs. Accordingly, displaying the OSDs in an easily viewable manner is important for improving operability of the projection apparatus.

On the other hand, examples of techniques to display projected images in an easily viewable manner include a method of, in a case where a projected image from the projection apparatus is projected onto a patterned projection target, correcting the projected image so that the way it looks can be closer to the way it would look when projected onto an all-white projection target. This method is hereafter referred to as pattern color correction (see, for example, International Publication No. 05/057941).

However, according to the techniques disclosed in Japanese Laid-Open Patent Publication (Kokai) No. 2008-83180 and International Publication No. 05/057941 above, it is difficult to display an OSD projected from the projection apparatus in an easily viewable manner while maintaining an image quality effect in the projection apparatus which provides a display by superimposing the projected image so as to obtain an image quality improvement effect on an observed object. The reason for this is that if the pattern color correction is performed for a projected image via, for example, the method described in International Publication No. 05/057941, the pattern color correction is performed for not only an OSD area of the projected image but the whole area, and therefore, a color and pattern of an observed object are canceled out by the projected image.

### SUMMARY OF THE INVENTION

The present invention provides a projection apparatus and a control method therefor which are capable of displaying an OSD from the projection apparatus in an easily viewable manner while maintaining an image quality improving effect, as well as a storage medium.

Accordingly, the present invention provides a projection apparatus comprising a projection unit configured to project an image on an observed object of a projection surface based on a projected image, a superimposing unit configured to superimpose a predetermined image on the projected image, and a correction unit configured to perform pattern color correction for at least an area of the projected image, wherein in a case where the projection unit projects an image based on the projected image superimposed with the predetermined image, the correction unit performs the pattern color correction for an area of the projected image where the predetermined image is superimposed, and not to perform the pattern color correction for another area of the projected image.

According to the present invention, an OSD from the projection apparatus is displayed in an easily viewable manner while an image quality improving effect is maintained.

Further features of the present invention will become apparent from the following description of exemplary embodiments (with reference to the attached drawings).

### BRIEF DESCRIPTION OF THE DRAWINGS

FIG. 1 is a diagram useful in explaining an image display system employing a projection apparatus according to embodiment 1.

FIG. 2 is a block diagram showing a hardware arrangement of the projection apparatus according to the present invention.

FIG. 3 is a block diagram showing an internal arrangement of an image processing unit in FIG. 2 according to the embodiment 1.

FIG. 4 is a flowchart showing the procedure of an OSD display process which is carried out by the projection apparatus.

FIGS. 5A and 5B are views showing a state where the projection apparatus project an OSD onto printed matter.

FIG. 6 is a diagram useful in explaining an image display system employing a plurality of projection apparatuses according to embodiment 2.

FIG. 7 is a block diagram showing an internal arrangement of an image processing unit in FIG. 2 according to embodiment 3.

### DESCRIPTION OF THE EMBODIMENTS

Embodiments of the present invention will now be described in detail with reference to the drawings.

### Embodiment 1

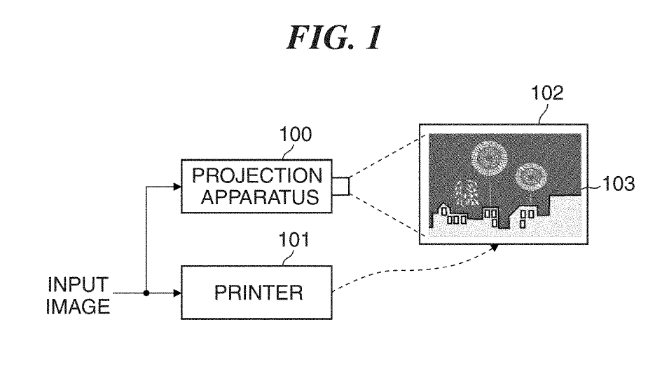

FIG. 1 is a diagram useful in explaining an image display system that uses a projection apparatus 100 according to embodiment 1.

First, the same input image is input to the projection apparatus 100 and a printer 101. The projection apparatus 100 performs predetermined image processing on the input image to generate a projected image 103 and then projects the projected image 103 onto a projection surface. Operations performed in the projection apparatus 100 will be described later in detail.

The printer 101 prints the input image and outputs a printed material 102. The printed material 102 is placed on the projection surface of the projection apparatus 100. It should be noted that the projected image 103 is projected from the projection apparatus 100 in a manner being superimposed on the printed matter 102 placed on the projection surface. By thus projecting the projected image 103 relating to the printed material 102, a dynamic range of luminance of the printed material 102 is improved.

It should not be noted that the projected image 103 should not always be substantially the same image as the printed material 102, but for example, may be what is called a gray-scale image obtained by extracting only luminance components from the input image. The projected image 103 may also be an image of which entire surface is comprised of such a white pattern as to uniformly increase reflective intensity of the printed material 102. Namely, the projected image 103 has only to be an image that is able to improve image quality (dynamic range of luminance) of the printed material 102 in a case where it is superimposed on the printed material 102. More specifically, contrast of the printed material 102 is enhanced by projecting the projected image 103 onto the printed material 102.

Moreover, although in the description of the present embodiment, it is assumed that an observed object is the printed material 102, onto which the projected image 103 is projected, the observed object is not limited to this but may be, for example, a painting or a wall of a building. In this case, the projection apparatus 100 can generate the projected image 103 based on an input image obtaining by picking up an image of a painting or a wall of a building which is the observed object.

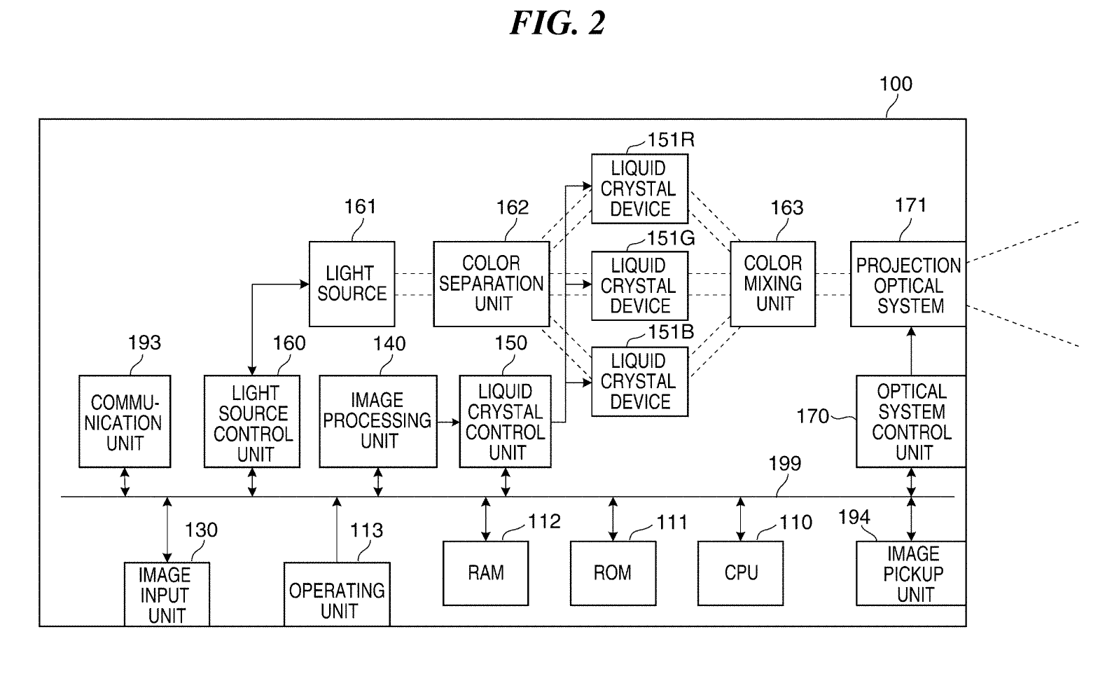

FIG. 2 is a block diagram showing a hardware arrangement of the projection apparatus 100 in FIG. 1.

The projection apparatus 100 according to the present embodiment has a CPU 110, a ROM 111, a RAM 112, an operating unit 113, an image input unit 130, and an image processing unit 140. The projection apparatus 100 also has a liquid crystal control unit 150, liquid crystal devices 151R, 151G, and 151B, a light source control unit 160, a light source 161, a color separation unit 162, a color mixing unit 163, an optical system control unit 170, and a projection optical system 171. The projection apparatus 100 also has a communication unit 193 and an image pickup unit 194. It should be noted that the CPU 110, the ROM 111, the RAM 112, the liquid crystal control unit 150, the light source control unit 160, and the optical system control unit 170 are collectively referred to as a projection controller that controls projecting operations of the projection apparatus 100.

The CPU 110 controls the entire projection apparatus 100, the ROM 111 holds control programs describing procedures of processing performed by the CPU 110, and the RAM 112 acts as a work memory to temporarily store control programs and data. OSDs and data, which is to be used by a pattern color correction unit 145, to be described later, are also recorded in the ROM 111. The CPU 110 is capable of temporarily storing still image data and moving image data received from the communication unit 193 and reproducing them by means of programs held in the ROM 111. The RAM 112 is capable of temporarily storing images and video obtained by the image pickup unit 194.

The operating unit 113, which is comprised of, for example, a switch and a dial, receives instructions from a user and sends instruction signals to the CPU 110. The operating unit 113 may send predetermined instruction signals to the CPU 110 based on signals received by, for example, a signal receiving unit (such as an infrared receiving unit) that receives signals from a remote control. The CPU 110 controls the entire projection apparatus 100 based on control signals input from the operating unit 113 and the communication unit 193.

The image input unit 130 receives images sent from an external apparatus (not shown). The external apparatus may be of any type such as a personal computer, a camera, a cellular phone, a smart phone, a hard disk recorder, or a game machine insofar as it is capable of outputting images.

The image processing unit 140, which is comprised of, for example, a microprocessor for image processing, makes changes in the number of frames, the number of pixels, a gradation value, an image shape, and so forth to an image received from the image input unit 130 and then sends the image to the liquid crystal control unit 150. It should be noted that the image processing unit 140 does not have to be a special-purpose microprocessor, and for example, the CPU 110 may perform the same processing as the image processing unit 140 does in accordance with programs stored in the ROM 111. The image processing unit 140 is capable of performing functions such as frame decimation, frame interpolation, resolution conversion (scaling), distortion correction (keystone correction), luminance correction, and color correction. The image processing unit 140 is also capable of generating a desired test pattern image and sending it to the liquid crystal control unit 150. The image processing unit 140 is also capable of making the changes described above to images or video reproduced by the CPU 110 as well as images received from the image input unit 130. The image processing unit 140 is also capable of superimposing an OSD, which is stored in advance in the ROM 111, on an image signal received from the image input unit 130 and outputting them.

Based on an image output from the image processing unit 140, the liquid crystal control unit 150 controls voltage applied to pixels of the liquid crystal devices 151R, 151G, and 151B to adjust transmittance of the liquid crystal devices 151R, 151G, and 151B. The liquid crystal device 151R is a liquid crystal device for red and is for adjusting transmittance of red light rays among light rays output from the light source 161 and separated into red (R), green (G), and blue (B) light rays by the color separation unit 162. The liquid crystal device 151G is a liquid crystal device for green and is for adjusting transmittance of green light rays among light rays output from the light source 161 and separated into red (R), green (G), and blue (B) light rays by the color separation unit 162. The liquid crystal device 151B is a liquid crystal device for blue and is for adjusting transmittance of blue light rays among light rays output from the light source 161 and separated into red (R), green (G), and blue (B) light rays by the color separation unit 162.

The light source control unit 160 controls turning-on/off of the light source 161 and the amount of light from the light source 161 and is comprised of a microprocessor for control. The light source control unit 160 does not have to be a special-purpose microprocessor, and for example, the CPU 110 may perform the same processing as the light-source control unit 160 in accordance with programs stored in the ROM 111. The light source 161 outputs light rays for projecting the generated projected image 103 onto a projection surface, not shown, such as a screen and may be, for example, a halogen lamp, a xenon lamp, or a high-pressure mercury lamp. The color separation unit 162 separates light output from the light source 161 into red (R), green (G), and blue (B) light rays and is comprised of, for example, a dichroic mirror or a prism. It should be noted that if LEDs or the like for the respective colors are used as the light source 161, the color separation unit 162 is dispensed with. The color mixing unit 163 mixes red (R), green (G), and blue (B) light that has passed through the liquid crystal devices 151R, 151G, and 151B and is comprised of, for example, a dichroic mirror or a prism. Light obtained by the color mixing unit 163 mixing the red (R), green (G), and blue (B) components is sent to the projection optical system 171. At this time, the liquid crystal devices 151R, 151G, and 151B are controlled by the liquid crystal control unit 150 so as to have light transmittance suitable for an image input from the image processing unit 140. Namely, in a case where the light mixed by the color mixing unit 163 is projected onto the projection surface by the projection optical system 171, the projected image 103 corresponding to the image input by the image processing unit 140 is displayed on the screen.

The optical system control unit 170 controls the projection optical system 171 and is comprised of a microprocessor for control. The optical system control unit 170 does not have to be a special-purpose microprocessor, and for example, the CPU 110 may perform the same processing as the optical system control unit 170 in accordance with programs stored in the ROM 111. The projection optical system 171 projects mixed light output from the color mixing unit 163 onto the projection surface and is comprised of a plurality of lenses and an actuator for actuating these lenses. In the optical system control unit 170, the plurality of lenses is actuated by the actuator to, for example, zoom in or out the projected image 103 and adjust a focus of the projected image 103.

The communication unit 193 receives control signals, still image data, moving image data, and so forth from an external apparatus. The communication unit 193 may be, for example, a wireless LAN, a USB, or a Bluetooth (registered trademark), and a communication method used by the communication unit 193 is not particularly limited. The communication unit 193 may also carry out CEC communications via a terminal of the image input unit 130 if the terminal is, for example, an HDMI (registered trademark) terminal.

Here, the external apparatus may be any type such as a personal computer, a camera, a cell phone, a smart phone, a hard disk recorder, a game machine, or a remote control insofar as it is capable of communicating with the projection apparatus 100.

The image pickup unit 194 is capable of picking up an image of an object around the projection apparatus 100 according to the present embodiment and shooting an image projected via the projection optical system 171 (taking an image of the projection surface). The image pickup unit 194 sends an obtained picked-up image to the CPU 110, which in turn temporarily stores the picked-up image in the RAM 112, and based on a program stored in the ROM 111, converts it into still image data or moving image data. The image pickup unit 194 includes a lens that obtains an optical image of a subject, an actuator that actuates the lens, a microprocessor that controls the actuator, an image pickup device that converts the optical image into an image signal, an AD conversion unit that performs analog-to-digital conversion of the image signal obtained by the image pickup device, and so forth. The data bus 199 is a bus that connects the components constituting the projection apparatus 100 to one another and is capable of communicating control signals, OSDs, and so forth.

It should be noted that the image processing unit 140, the liquid crystal control unit 150, the light source control unit 160, and the optical system control unit 170 according to the present embodiment may be a single or multiple microprocessors capable of performing the same processing as they do. Alternatively, for example, in accordance with programs stored in the ROM 111, the CPU 110 may perform the same processing as those blocks do.

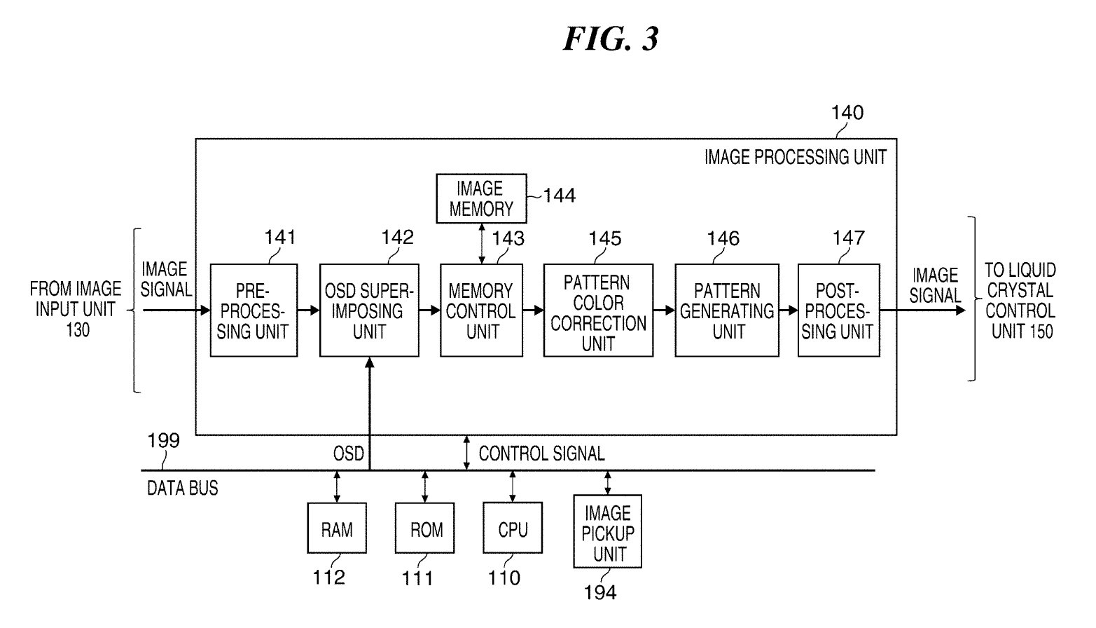

Next, referring to FIG. 3, a description will be given of an internal arrangement of the image processing unit 140 in FIG. 2.

The image processing unit 140 is comprised of blocks consisting of a pre-processing unit 141, an OSD superimposing unit 142, a memory control unit 143, an image memory 144, a pattern color correction unit 145, a pattern generating unit 146, and a post-processing unit 147. Each of these blocks constituting the image processing unit 140 is connected to the CPU 110, the ROM 111, the RAM 112, and the image pickup unit 194 via the data bus 199.

The pre-processing unit 141 subjects an image, which is input from the image input unit 130, to display layout conversion processes including a color space conversion process and an expansion-reduction process so that the image can have a color space and a resolution suitable for the liquid crystal devices 151R, 151G, and 151B. The OSD superimposing unit 142 superimposes an OSD, which is stored in advance in the ROM 111, on an image input to itself in accordance with an instruction from the CPU 110.

The memory control unit 143 carries out conversion processes on a temporal axis such as an IP conversion process and a frame rate conversion process and provides control to issue a memory address of the image memory 144, which is used to correct a shape of a projected image, and write and read an image. The frame rate conversion process carried out by the memory control unit 143 includes a frame rate doubling process implemented by reading the same image twice from the image memory 144.

The pattern color correction unit 145 subjects an image, which is input to itself, to a pattern color correction process so that the way the projected image 103 projected on the printed material 102 looks can be closer to the way the projected image 103 would look in a case where it is projected on an all-white projection target. In the present embodiment, however, it is assumed that the pattern color correction unit 145 performs pattern-color correction on an area of an image, which is input to the pattern color correction unit 145, where an OSD is superimposed. In other words, the pattern color correction unit 145 lowers contrast of the printed material 102 and performs correction on an area including an area of the projected image 103 where an OSD is superimposed so that the OSD on the projected image 103 can look as if it were projected onto an all-white screen. It should be noted that details of operations performed by the pattern color correction 145 will be described later.

The pattern generating unit 146 generates a desired image pattern such as an all-black or all-white image or a gradation image and outputs it to the post-processing unit 147 in accordance with an instruction from the CPU 110. The post-processing unit 147 carries out a correction process to correct for display unevenness (unevenness of color and unevenness of brightness) and disclinations caused by the liquid crystal devices 151R, 151G, and 151B and the projection optical system 171. The post-processing unit 147 also performs image processing such as gamma correction according to gradation performance of the liquid crystal devices 151R, 151G, and 151B.

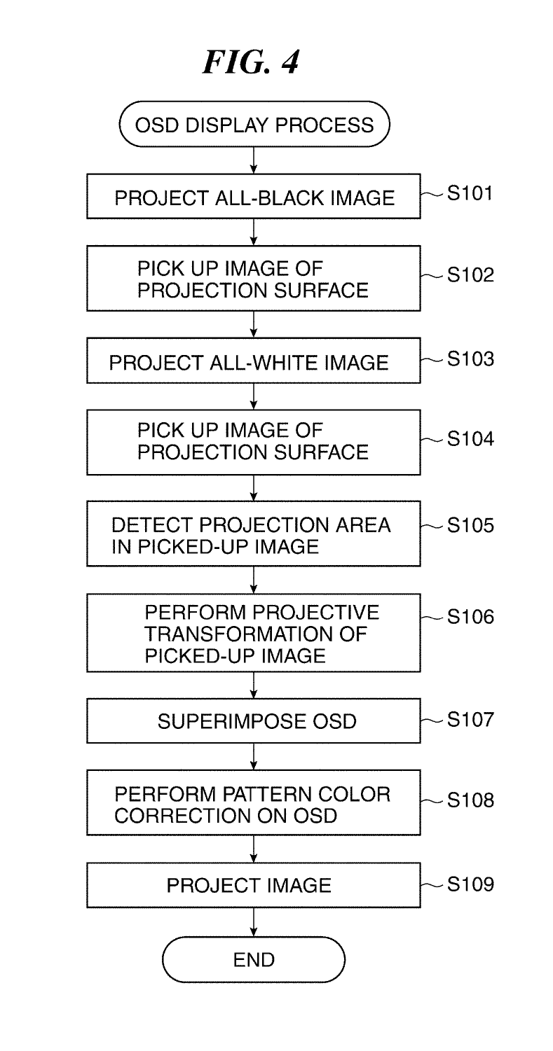

Next, referring to a flowchart of FIG. 4, a description will be given of the procedure of an OSD display process which is carried out by the projection apparatus 100 according to the present invention.

Upon receiving an instruction to display an OSD from a user of the projection apparatus 100 via the operating unit 113, the components constituting the projection apparatus 100 perform operations described in this flowchart.

First, in step S101, the CPU 110 instructs the pattern generating unit 146 to generate a test pattern of an all-black image of which entire surface is black. The pattern generating unit 146 generates a test pattern of an all-black image as instructed by the CPU 110 and outputs it to the post-processing unit 147. This test pattern is output from the image processing unit 140, then formed on the liquid crystal devices 151R, 151G, and 151B by the liquid crystal control unit 150, and projected via the projection optical system 171 in a manner being superimposed on the printed material 102.

Next, in step S102, the CPU 110 instructs the image pickup unit 194 to pick up an image of the projection surface of the projection apparatus 100. The image pickup unit 194 picks up an image of the projection surface of the projection apparatus 100 and records the picked-up image IMG_B in the RAM 112.

In step S103, the CPU 110 instructs the pattern generating unit 146 to generate a test pattern of an all-white image of which entire surface is white. The pattern generating unit 146 generates a test pattern of an all-white image as instructed by the CPU 110 and outputs it to the post-processing unit 147. This test pattern is output from the image processing unit 140, then formed on the liquid crystal devices 151R, 151G, and 151B by the liquid crystal control unit 150, and projected via the projection optical system 171.

Then, in step S104, the CPU 110 instructs the image pickup unit 194 to pick up an image of the projection surface of the projection apparatus 100. The image pickup unit 194 picks up an image of the projection surface of the projection apparatus 100 and records the picked-up image IMG_W in the RAM 112.

After that, in step S105, the CPU 110 detects an area onto which the projected image 103 of the projection apparatus 100 is to be projected (hereafter referred to as a “projection area”) from the picked-up images IMG_B and IMG-W. Specifically, the CPU 110 obtains a difference between the picked-up images IMG_B and IMG-W and determines an area where the difference is greater than a predetermined value as the projection area in the picked-up images IMG_B and IMG_W.

Then, in step S106, the CPU 110 creates an image IMG_WP by performing projective transformation on the picked-up image IMG_W so that a shape of the projection area in the picked-up image IMG_W detected in the step S105 can be the same as that of the projected image 103. In the image IMG_WP thus created, information on a color and pattern of the printed material 102 in the projection area of the projection apparatus 100 is recorded.

Then, in step S107, the CPU 110 determines an OSD area where an OSD is to be superimposed, and instructs the OSD superimposing unit 142 to superimpose the OSD on the determined OSD area. The OSD superimposing unit 142 reads out the OSD from the ROM 111, and for an image input to the OSD superimposing unit 142, superimposes the OSD on the OSD area designated by the CPU 110. The image on which the OSD has been superimposed by the OSD superimposing unit 142 is input to the pattern color correction unit 145 via the memory control unit 143 and the image memory 144.

After that, in step S108, by following a procedure described below, the pattern color correction unit 145 performs pattern color correction so that the way the OSD area of the image, on which the OSD was superimposed in the step S107 in which the image is projected onto the printed material 102, looks closer to the way the OSD area would look in a case where the image is projected on an all-white projection target. However, not only the method used in the present embodiment but any other well-known methods may be used for this pattern color correction.

First, the pattern color correction unit 145 generates pattern color correction data based on the data (in the present embodiment, the image IMG_WP) in which the color and pattern of the printed material 102 are recorded. It is assumed that the pattern color correction data in the present embodiment is comprised of RGB gain values (GAIN_R, GAIN_G, GAIN_B) for each pixel to be corrected. Then, the pattern color correction unit 145 uses the pattern color correction data to carry out correction processes represented by equations 1 to 3 for the area where the OSD is superimposed in the image input to the pattern color correction unit 145.

OUT_R=IN_R×GAIN_R (equation 1)

OUT_G=IN_G×GAIN_G (equation 2)

OUT_B=IN_B×GAIN_B (equation 3)

It should be noted that IN_R, IN_G, and IN_B are RGB gradation values in pixels in the area to be corrected (in the present embodiment, the area where the OSD is superimposed) in the image input to the pattern color correction unit 145. OUT_R, OUT_G, and OUT_B are RGB gradation values in pixels in the area to be corrected in an output image from the pattern color correction unit 145.

A description will now be given of an example of a procedure by which the pattern color correction unit 145 obtains the RGB gain values GAIN_R, GAIN_G, and GAIN_B which are the pattern color correction data.

It is assumed here that gradation values of an image obtained by picking up in advance a white image (an image with the highest gradations of all the RGB colors) projected onto a predetermined projection surface (its entire surface is preferably white) are CamRef_R, CamRef_G, and CamRef_B. It should be noted that the gradation values CamRef_R, CamRef_G, and CamRef_B are recorded in advance in the ROM 111.

First, the pattern color correction unit 145 reads the gradation values CamRef_R, CamRef_G, and CamRef_B from the ROM 111.

Next, the pattern color correction unit 145 obtains gradation values of the image IMG_WP, that is, gradation values CamP_R, CamP_G, and CamP_B of an image obtained by the image pickup unit 194 picking up an image of the printed material 102 onto which a test pattern of an all-white image is projected.

Here, suppose that the pattern color correction unit 145 performs correction so that the way the color of the projected image 103 projected on the printed material 102 looks can be closer to the way the color of the projected image 103 would look in a case where it is projected on an all-white projection target. It is assumed here that CamGoal_R, CamGoal_G, and CamGoal_B are gradation values of an image obtained by the image pickup unit 194 picking up an image of the projection surface onto which the projected image 103 corrected by the pattern color correction and superimposed on the printed material 102.

The pattern color correction unit 145 obtains gain values GainCam_R, GainCam_G, and GainCam_B represented by equations 4 to 6 below.

CamGoal_R=CamP_R×GainCam_R (equation 4)

CamGoal_G=CamP_G×GainCam_G (equation 5)

CamGoal_B=CamP_B×GainCam_B (equation 6)

It should be noted that a relationship expressed by an equation 7 holds among the gradation values CamGoal_R, CamGoal_G, and CamGoal_B.

CamRef_R: CamRef_G: CamRef_B=CamGoal_R: CamGoal_G: CamGoal_B (equation 7)

It should be noted that the gain values GainCam_R, GainCam_G, and GainCam_B may be any values as long as they satisfy the relationship expressed by the equation 7, but it is preferred that a value corresponding to a color of a minimum value among the gradation values CamP_R, CamP_G, and CamP_B is 1. For example, in a case where the following relationship, CamP_R>CamP_G>CamP_B, holds, it is preferred that the gain value GainCam_B is equal to 1. This enables the pattern color correction to be performed without making the projected image 103 darker than necessary.

Here, suppose that the projected image 103, which has been corrected by the pattern color correction so as to make the pattern color of the printed material 102 less visible, is projected onto a predetermined projection surface (its entire surface is preferably white). Supposing that the image pickup unit 194 then picks up an image of the projection surface, relationships expressed by equations 8 to 10 below hold among gradation values of the picked-up image CamRefComp_R, CamRefComp_G, and CamRefComp_B.

CamRef_Comp_R=CamRef_R×GainCam_R (equation 8)

CamRef_Comp_G=CamRef_G×GainCam_G (equation 9)

CamRef_Comp_B=CamRef_B×GainCam_B (equation 10)

The pattern color correction unit 145 calculates the gradation values CamRef_Comp_R, CamRef_Comp_G, and CamRef_Comp_B based on the equations 8 to 10.

Then, the pattern color correction unit 145 obtains IMG_Comp_R, IMG_Comp_G, and IMG_Comp_B according to equations 11 to 13. It should be noted that IMG_Comp_R, IMG_Comp_G, and IMG_Comp_B are pixel values of an image output from the pattern color correction unit 145 in a case where a gradation value of an image obtained by the image pickup unit 194 picking up the projection surface onto which the projected image 103 is projected is CamRef_R. Also, GainRef_R, GainRef_G, and GainRef_B are coefficients representing a relationship between gradation values of an image obtained by the image pickup unit 194 picking up the projected image 103 projected onto a predetermined projection surface (its entire surface s preferably white) and gradation values of an image output from the pattern color correction unit 145. The coefficients GainRef_R, GainRef_G, and GainRef_B are recorded in advance in the ROM 111.

IMG_Comp_R=GainRef_R×CamRef_Comp_R (equation 11)

IMG_Comp_G=GainRef_G×CamRef_Comp_G (equation 12)

IMG_Comp_B=GainRef_B×CamRef_Comp_B (equation 13)

Then, the pattern color correction unit 145 calculates the gain values GAIN_R, GAIN_G, and GAIN_B according to equations 14 to 16. It should be noted that IMG_MAX is a gradation value representing a white image (gradations of all the RGB colors are maximum) among gradation values of an image input to the pattern color correction unit 145.

GAIN_R=IMG_Comp_R/IMG_MAX (equation 14)

GAIN_G=IMG_Comp_G/IMG_MAX (equation 15)

GAIN_B=IMG_Comp_B/IMG_MAX (equation 16)

By following the above procedure, the pattern color correction unit 145 calculates the RGB gain values GAIN_R, GAIN_G, and GAIN_B which are the pattern color correction data.

By repeatedly performing the steps described above for each pixel of the area where the OSD is superimposed, the pattern color correction unit 145 generates the RGB gain values for each pixel to be corrected and carries out the correction process according to the equations 1 to 3 above.

After that, in step S109, the image corrected by the pattern color correction unit 145 is output from the image processing unit 140, formed on the liquid crystal devices 151R, 151G, and 151B by the liquid crystal control unit 150, and projected via the projection optical system 171.

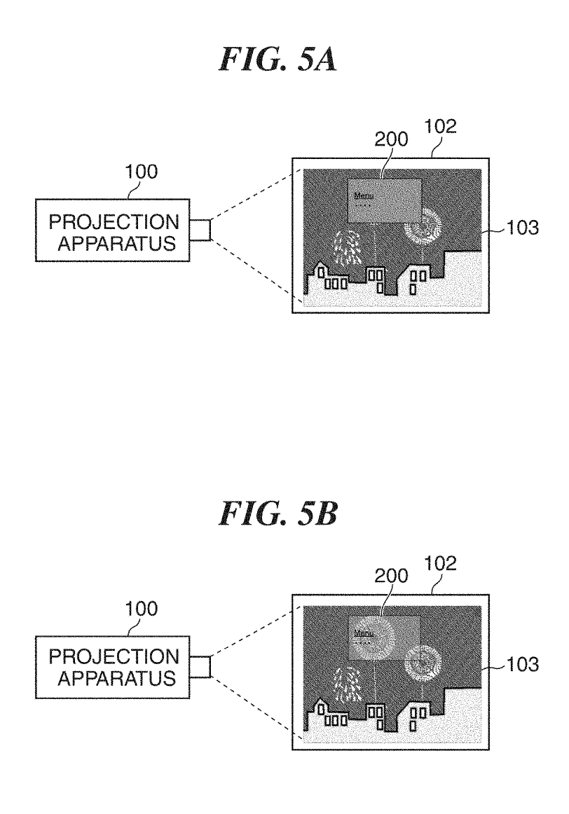

FIG. 5A shows an example of the way an OSD looks in a case where the projection apparatus 100 according to the present embodiment projects it onto the printed material 102. For an area 200 where the OSD is displayed in the projected image 103, the color pattern correction is performed to cancel out a color and pattern of an observed object by the components constituting the projection apparatus 100 operating in accordance with the steps described in the flowchart of FIG. 4. Namely, the projection apparatus 100 according to the present embodiment projects the projected image 103 that has been corrected so as to cancel out at least one of a color, pattern, and contrast of the printed material 102 (observed object) which corresponds to the area 200 where the OSD is displayed. On the other hand, as for the other area of the projected image 103, the projection apparatus 100 projects the projected image 103 so as to enhance at least one of the color, pattern, and contrast of the printed material 102 (observed object). Therefore, the OSD is displayed in an easily viewable manner as compared to the case where the color pattern correction has not been performed on the OSD (the area 200 in FIG. 5B).

According to the present embodiment described above, in a case where the projection apparatus 100 superimposes the OSD in the OSD area of the projected image 103 when displaying the projected image 103 in a manner being overlaid on the printed material 102 which is the observed object so as to improve image quality of the observed object, the color pattern correction is performed for only the OSD area. Namely, since the color pattern correction is not performed in such a case for the area other than the OSD area of the projected image 103, the OSD of the projection apparatus 100 is displayed in an easily viewable manner while the effect of improving image quality is maintained.

It should be noted that in the above description, upon receiving an instruction to display the OSD from the user of the projection apparatus 100 via the operating unit 113, the components constituting the projection apparatus 100 starts the process described in the flowchart of FIG. 4. However, when the process is started is not limited to this. For example, after the user completes installation of the projection apparatus 100 and completes alignment between the printed material 102 and the projected image 103, the steps S101 to S106 may be performed in advance. In this case, the projection apparatus 100 has only to perform the steps S107 to S109 upon receiving an instruction to display the OSD from the user of the projection apparatus 100 via the operating unit 113.

Moreover, in the above description, the projection apparatus 100 according to the present embodiment performs the color pattern correction based on data about the color and pattern of the printed material 102 which is the observed object recorded in the image IMG_WP as in the step S108. The data on the color and pattern of the printed material 102, however, should not always be obtained via this method. For example, the data on the color and pattern of the observed object may be calculated from the input image shown in FIG. 1. Alternatively, the CPU 110 may obtain information on the color and pattern of the observed object from an external apparatus via the communication unit 193.

### Embodiment 2

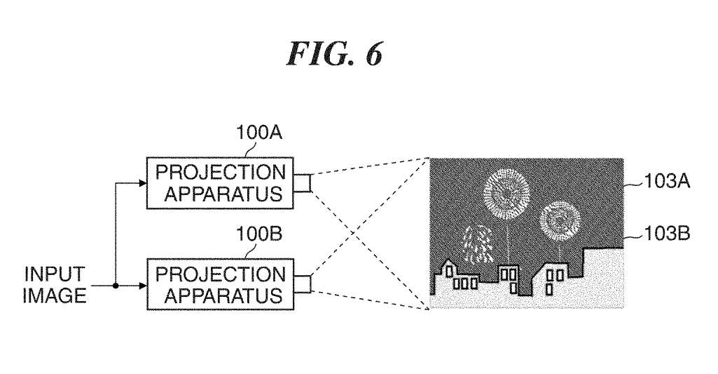

FIG. 6 is a diagram useful in explaining an image display system that uses a plurality of the projection apparatuses 100A and 100B according to embodiment 2. An internal arrangement of the projection apparatuses 100A and 100B is the same as that of the projection apparatus 100 in the embodiment 1 described above.

The same input image is input to the projection apparatuses 100A and 100B. The projection apparatuses 100A and 100B perform predetermined image processing to generate projected images 103A and 103B, respectively, and then project the projected images 103A and 103B onto the projection surface in a manner being superimposed on each other.

Here, a description will be given of how the components of the projection apparatus 100A according to the present embodiment operate in a case where the projection apparatus 100A displays an OSD. These operations are substantially the same as those of the projection apparatus 100 described above in the embodiment 1 with reference to the flowchart of FIG. 4. Thus, only differences from the operations of the embodiment 1 described above will be described below, and description of the operations corresponding to those of the embodiment 1 is omitted.

The operations of the projection apparatus 100A in steps S101 to S107 are the same as those of the embodiment 1, and therefore, description thereof is omitted. It should be noted that in the image display system according to the present embodiment, information on a color and pattern of the projected image 103B projected from the projection apparatus 100B is recorded in the picked-up images IMG_B and IMG_W obtained by the image pickup unit 194 in the steps S102 and S104.

Next, in step S108, by following a procedure below, the pattern color correction unit 145 performs pattern color correction to reduce the pattern of the projected image 103B in an area of the projected image 103A where the OSD is displayed. However, this pattern color correction is not limited to the process used in the present embodiment described below, but may be performed by any well-known method.

First, the pattern color correction unit 145 generates pattern color correction data based on the data (in the present embodiment, the image IMG_WP) in which the color and pattern of the projected image 103B are recorded. It is assumed that in the present embodiment, the pattern color correction data is comprised of RGB offset values (OFFSET_R, OFFSET_G, OFFSET_B) for each pixel to be corrected. Then, the pattern color correction unit 145 uses the pattern color correction data to carry out correction processes expressed by equations 21 to 23 for the area where the OSD is superimposed in the image input to the pattern color correction unit 145.

OUT_R=IN_R−OFFSET_R (equation 21)

OUT_G=IN_G−OFFSET_G (equation 22)

OUT_B=IN_B−OFFSET_B (equation 23)

It should be noted that IN_R, IN_G, and IN_B are RGB gradation values in pixels in the area to be corrected (in the present embodiment, the area where the OSD is superimposed) in the image input to the pattern color correction unit 145. Also, OUT_R, OUT_G, and OUT_B are RGB gradation values in pixels in the area to be corrected in an output image from the pattern color correction unit 145.

A description will now be given of an example of a procedure by which the pattern color correction unit 145 obtains the RGB offset values OFFSET_R, OFFSET_G, and OFFSET_B which are the pattern color correction data.

It is assumed here that gradation values of an image obtained by picking up in advance a white image (an image with the highest gradations of all the RGB colors) projected onto a predetermined projection surface (its entire surface is preferably white) are CamRef_R, CamRef_G, and CamRef_B. It should be noted that the gradation values CamRef_R, CamRef_G, and CamRef_B are recorded in advance in the ROM 111.

First, the pattern color correction unit 145 reads the gradation values CamRef_R, CamRef_G, and CamRef_B from the ROM 111. Next, the pattern color correction unit 145 obtains gradation values CamP_R, CamP_G, and CamP_B of the image IMG_WP created in the step S106.

Here, suppose that the pattern color correction unit 145 corrects the projected image 103A so that the way a color of an OSD area looks in a case where the projected image 103A is projected in a superimposed manner onto the projection surface onto which the projected image 103B is projected can be closer to the way a color of the OSD area would look in a case where the projected image 103A is projected onto an all-white projection target. It is assumed that CamGoal_R, CamGoal_G, and CamGoal_B are gradation values of an image obtained by the image pickup unit 194 picking up an image of the projection surface onto which the projected image 103A corrected by the pattern color correction and the projected image 103B are projected in a superimposed manner.

At this time, the pattern color correction unit 145 obtains offset values OffsetCam_R, OffsetCam_G, and OffsetCam_B represented by equations 24 to 26 below.

CamGoal_R=CamP_R×OffsetCam_R (equation 24)

CamGoal_G=CamP_G×OffsetCam_G (equation 25)

CamGoal_B=CamP_B×OffsetCam_B (equation 26)

It should be noted that a relationship expressed by an equation 27 holds among the gradation values CamGoal_R, CamGoal_G, and CamGoal_B.

CamRef_R: CamRef_G: CamRef_B=CamGoal_R: CamGoal_G: CamGoal_B (equation 27)

It should be noted that the offset values OffsetCam_R, OffsetCam_G, and OffsetCam_B may be any values as long as they satisfy the relationship expressed by the equation 27, but it is preferred that a value corresponding to a color of a minimum value among the gradation values CamP_R, CamP_G, and CamP_B is zero. For example, in a case where the following relationship, CamP_R>CamP_G>CamP_B, holds, it is preferred that the offset value OffsetCam_B is equal to zero. This enables the pattern color correction to be performed without making the projected image 103A darker than necessary.

Then, the pattern color correction unit 145 derives RGB offset values OFFSET_R, OFFSET_G, and OFFSET_B, which are pattern color correction data, according to equations 28 to 30. It should be noted that GainRef_R, GainRef_G, and GainRef_B are coefficients representing a relationship between gradation values of an image obtained by the image pickup unit 194 picking up the projected image 103A projected onto a predetermined projection surface and gradation values of an image output from the pattern color correction unit 145. It is preferred that the entire surface of the predetermined projection surface is white. The coefficients GainRef_R, GainRef_G, and GainRef_B are recorded in advance in the ROM 111.

OFFSET_R=OffsetCam_R×GainRef_R (equation 28)

OFFSET_G=OffsetCam_G×GainRef_G (equation 29)

OFFSET_B=OffsetCam_B×GainRef_B (equation 30)

By following the above procedure, the pattern color correction unit 145 calculates the RGB offset values OFFSET_R, OFFSET_G, and OFFSET_B which are the pattern color correction data.

By repeatedly performing the steps described above for each pixel of the area where the OSD is superimposed, the pattern color correction unit 145 generates the RGB offset values for each pixel to be corrected and carries out the correction process according to the equations 21 to 23.

### Embodiment 3

In the embodiments 1 and 2 described above, the pattern color correction is performed for an area where an OSD is superimposed in an image signal on which the OSD is superimposed by the OSD superimposing unit 142.

On the other hand, a projection apparatus 100C according to embodiment 3 performs pattern color correction on an OSD before the OSD is superimposed by the OSD superimposing unit 142. It should be noted that an image processing unit 140A of the projection apparatus 100C according to the present embodiment has substantially the same hardware arrangement as the one shown in FIG. 2, and therefore, the same components as those in FIG. 2 are designated by the same reference symbols, detailed description of which, therefore, is omitted.

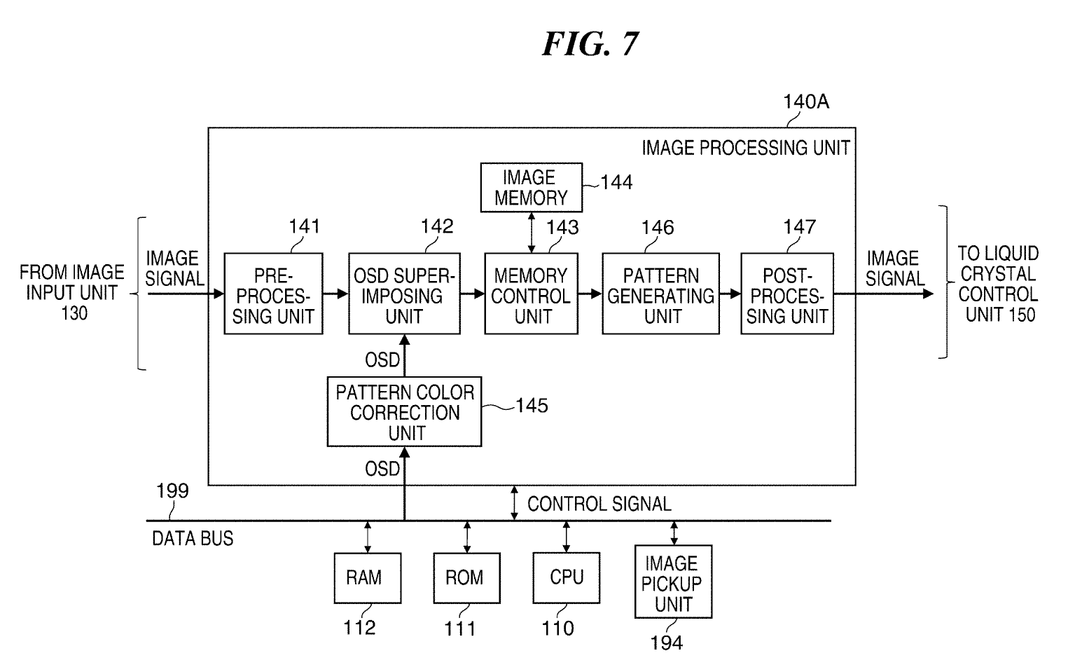

FIG. 7 is a diagram showing an internal arrangement of the image processing unit 140A in FIG. 2 according to the present embodiment.

An OSD recorded in the ROM 110 is input first to the pattern color correction unit 145. The pattern color correction unit 145 performs the pattern color correction described above on the OSD input to itself and sends the corrected OSD to the OSD superimposing unit 142. The OSD superimposing unit 142 superimposes the OSD, which has been subjected to the pattern color correction, on an image input to itself and outputs the image on which the OSD is superimposed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-122214, filed Jun. 22, 2017, which is hereby incorporated by reference herein in its entirety.

What is claimed is:

1. A projection apparatus comprising:
a projection unit configured to project an image on an observed object of a projection surface based on a projected image;
a superimposing unit configured to superimpose a predetermined image on the projected image; and
a correction unit configured to perform pattern color correction for at least an area of the projected image,
wherein in a case where the projection unit projects an image based on the projected image superimposed with the predetermined image, the correction unit performs the pattern color correction for an area of the projected image where the predetermined image is superimposed, and not to perform the pattern color correction for another area of the projected image.

2. The projection apparatus according to claim 1, wherein the pattern color correction is a correction for making the way the area where the predetermined image is superimposed looks closer to the way the area would look in a case where the projected image is projected onto an all-white projection target.

3. The projection apparatus according to claim 1, wherein the correction unit performs the pattern color correction for the area of the projected image after the superimposing unit superimposes the predetermined image on the projected image.

4. The projection apparatus according to claim 1, wherein the superimposing unit superimposes the predetermined image on the projected image after the correction unit performs the pattern color correction for the area of the projected image.

5. The projection apparatus according to claim 1, wherein the projected image is an image that improves a dynamic range of luminance of the observed object on the projection surface.

6. The projection apparatus according to claim 5, wherein the projected image is an image that uniformly improves a reflective intensity of the observed object on the projection surface.

7. The projection apparatus according to claim 1, wherein the correction unit comprises an obtaining unit that obtains gradation values of pixels in the area where the predetermined image is superimposed, and a calculation unit that calculates offset values for use in the pattern color correction based on the obtained gradation values.

8. The projection apparatus according to claim 7, wherein the obtaining unit obtains the gradation values based on data on a color and pattern of the observed object obtained from a picked-up image of the observed object on the projection surface.

9. The projection apparatus according to claim 7, wherein the obtaining unit that obtains the color and pattern of the observed object from an external apparatus.

10. The projection apparatus according to claim 1, wherein the observed object is an image projected onto the projection surface from another projection apparatus.

11. The projection apparatus according to claim 7, further comprising a generating unit configured to input an image for outputting a printed material that is the observed object and generate the projected image,
wherein the obtaining unit obtains the gradation values based on data on a color and pattern of the observed object obtained from the image.

12. The projection apparatus according to claim 1, wherein
the predetermined image is menu image for controlling at least one function of the projection apparatus.

13. A projection apparatus that projects a projected image related to an observed object in a manner being superimposed on the observed object on a projection surface, comprising:
a projection unit configured to project the projected image in a manner being superimposed on the observed object; and
a projection control unit configured to control the projected image so that a contrast of the observed object is lowered in a predetermined area of the observed object, and a contrast of the observed object is enhanced in the other area of the observed object.

14. A control method for a projection apparatus, comprising:
a projection step of projecting an image on an observed object of a projection surface based on a projected image;
a superimposing step of superimposing a predetermined image on the projected image; and
a correction step of performing pattern color correction for at least an area of the projected image,
wherein in a case where an image based on the projected image superimposed with the predetermined image is projected in the projection step, the pattern color correction is performed for an area of the projected image where the predetermined image is superimposed, and the pattern color correction is not performed for another area of the projected image in the correction step.

15. A non-transitory computer-readable storage medium storing a program for causing a computer to execute a control method for a projection apparatus, the control method comprising:
a projection step of projecting an image on an observed object of a projection surface based on a projected image;
a superimposing step of superimposing a predetermined image on the projected image; and
a correction step of performing pattern color correction for at least an area of the projected image,
wherein in a case where an image based on the projected image superimposed with the predetermined image is projected in the projection step, the pattern color correction is performed for an area of the projected image where the predetermined image is superimposed, and the pattern color correction is not performed for another area of the projected image where the OSD is superimposed in the correction step.
